(19) United States
(12) Patent Application Publication
(10) Pub. No.: US 2007/0245955 A1
(43) Pub. Date: Oct. 25, 2007

(54) Substrate holder for optical coating machines

(75) Inventors: David M. Stohl, Sebastopol, CA (US); Donald L. Dunning, Santa Rosa, CA (US)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: JDS Uniphase Corporation, Milpitas, CA (US)

(21) Appl. No.: 11/410,599

(22) Filed: Apr. 25, 2006

(51) Int. Cl. B05C 13/02

(52) U.S. Cl. 118/500

(57) ABSTRACT

A substrate holder for supporting substrates during coating processes includes an expandable outer frame, and a plurality of flexible arms defining a mesh or lattice like structure. Openings, formed by the interconnecting flexible arms, are defined by a plurality of resilient walls, which alternatively flex into and out of each opening providing equally spaced points of support for each substrate.

### CROSS-REFERENCE TO RELATED APPLICATIONS

The present application does not claim any priority.

### TECHNICAL FIELD

The present invention relates to a substrate holder, and in particular to a substrate holder for supporting a plurality of closely packed substrates for use in an optical coating machine.

### BACKGROUND OF THE INVENTION

Mirrors used in high power lasers are coated with complex and precise multi-layer optical coatings deposited in a vacuum by a deposition process, e.g. physical vapor deposition (PVD). To ensure that the laser performance is not degraded, it is imperative that the generation of particulates be avoided, so that the particles do not become embedded in the optical coating. A typical substrate for such laser mirrors is in the form of a small short glass cylinder, with a diameter of a few millimeters and a length of about half the diameter. The flat or near flat ends of the substrate are polished to the highest achievable geometrical and surface perfection.

With reference to FIG. 1, a conventional substrate holder 1, which supports substrates 2 during a mirror deposition process, includes a solid base 3 and an upper cover 4 with equally spaced openings 5 for receiving the substrates 2. An annular lip or spaced-apart feet 6 extend into the openings 5 and prevent the substrates 2 from falling out. The process of mounting the substrates 2 in the openings 5 often cause particulate generation, which, even for particles as small as one micron, can greatly degrade the performance of the laser. The area taken up by the upper cover 4 limits the number of substrates 2 that can be coated at one time, and provides a location for wasted coating materials to clump together before flaking off and potentially damaging the substrates 2. The multi-piece substrate holder 1 also necessitates time consuming assembly steps, and a complicated cleaning process.

An object of the present invention is to eliminate the shortcomings of the prior art by providing a substrate holder enabling the substrates to be easily mounted, tightly secured, and closely packed without particulate matter generation.

### SUMMARY OF THE INVENTION

Accordingly, the present invention relates to a device for holding a plurality of substrates comprising:

an outer frame defining an inner area; and

a plurality of interconnecting flexible arms extending from the outer frame into the inner area defining a plurality of openings with flexible walls, each opening sized to receive a substrate by deformation of the flexible walls.

### BRIEF DESCRIPTION OF THE DRAWINGS

The invention will be described in greater detail with reference to the accompanying drawings which represent preferred embodiments thereof, wherein:

FIG. 1 is a cross-sectional view of a conventional substrate holder;

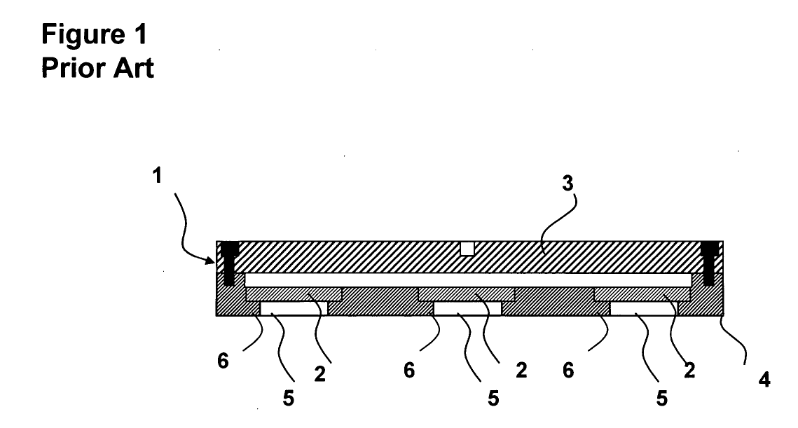

FIG. 2 is a side view of a coating chamber;

FIG. 3 is a isometric view of a substrate holder according to the present invention;

FIG. 4 is an exploded isometric view of the substrate holder of FIG. 3 mounted on a rotating spindle; and

FIG. 5 is an exploded isometric view of the substrate holder of FIG. 3 mounted in a mounting frame.

### DETAILED DESCRIPTION

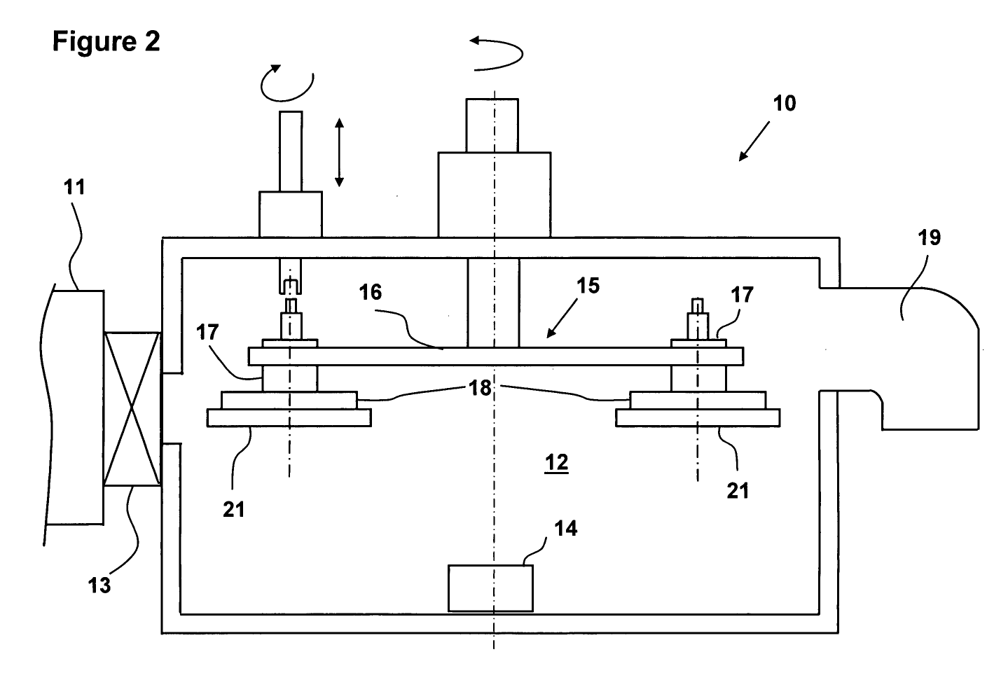

With reference to FIG. 2, a coating machine 10, e.g. a Physical Vapor Deposition (PVD) or a Chemical Vapor Deposition (CVD) system, for use with the present invention includes a load lock chamber, generally indicated at 11, and a process chamber 12 with a gate valve 13 therebetween. The gate valve 13 enables the pressure in the load lock chamber 11 to be brought to atmospheric pressure for loading and unloading of substrates or to be re-established to the pressure of the process chamber 12 for substrate transfer, independently of the pressure in the process chamber 12. Preferably, the load lock chamber 11 includes a loading container with a cassette elevator therein, and a transfer channel with a robotic arm therein for transferring the substrate holders between the load lock chamber 11 and the process chamber 12.

A cathode 14, and a planetary substrate support 15 are mounted within the process chamber 2. The planetary substrate support 15 comprises a main cylindrical platform 16 rotatable about a first axis, with a plurality of spindles 17, e.g. six, extending therefrom, each spindle 17 rotatable about its own axis, which are preferably parallel to the first axis, but may be at some other angle. In use, as the main platform 15 is rotated, each individual spindle 17 is also rotated to ensure even coating over all portions of each substrate. Each spindle 17 includes a latch 18 at the outer free end thereof for suspending a substrate holder 21, according to the present invention, over the cathode 13.

At least one cathode 13, preferably low arcing cathodes, are mounted inside the process chamber 12. Extra cathodes 13 may be provided for backup in case of failure or in case the coating supply in one cathode 13 becomes exhausted. Alternatively, several different cathodes 13 can be provided to enable the deposition of different coatings consecutively without opening up the process chamber 12 to the atmosphere. Preferably, minor adjustments can be made to the position of the cathode 13 by movement a mounting platform (not shown), manually or by remote control.

The process chamber 12 is evacuated through pumping port 19, while process gases are supplied to the process chamber 12 via mass flow controllers (not shown).

While sputter deposition vacuum systems have been described herein, the substrate support according to the present invention can be utilized with any other suitable coating system such as evaporative systems or CVD systems. The coating process can be enhanced by additional equipment such as shutters, masks, ion bombardment devices, advanced anode concepts, or plasma activation systems.

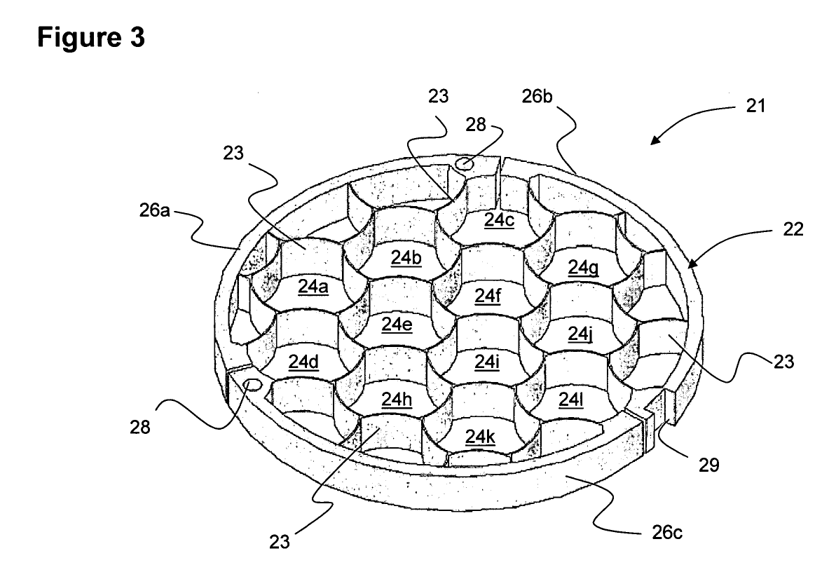

With reference to FIG. 3, the substrate holder 21, includes an outer frame 22 and a series of interconnected flexible arms 23 extending therefrom forming a mesh or lattice-like pattern. Multi-sided geometrically shaped openings 24a to 241 with flexible walls for receiving and supporting substrates are formed by the interconnecting arms 23. The flexible walls are resilient and spring biased into one of the openings 24a to 241 for squeezing the substrates therebetween at equally spaced apart locations. Preferably, the multi-sided openings 24a to 241 have walls, which alternatively flex inwardly and outwardly, whereby half of the walls support a substrate within each opening 24a to 241, while the other half of the walls support substrates in surrounding openings. With specific reference to opening 24f, preferably, each opening has six sides, i.e. hexagonal shaped, with every other side, i.e. three sides, bowing or flexing into the opening 24f and three sides bowing or flexing out of the opening 24f into adjacent openings 24c, 24e and 24j for supporting substrates therein. However, more or less sides can be provided depending upon specific needs and structures.

In the illustrated embodiment the flexible arms 23 are constructed of a sheet material, such as metal, and preferably a hardened steel providing a ruggedness, which would enable an aggressive cleaning with a minimum of particulate entrapment. Preferably, the sheet metal is between 0.1 and 0.2 inches thick, and wide enough to provide suitable support for the substrates. The flexible arms 23 form rectangular walls flexing or bowing into or out off each opening 24a to 241.

To facilitate mounting of the substrates within the substrate holder 21, the outer frame 22 is expandable enabling all of the openings 24a to 241 to thereby expand. Ideally, the outer frame 22 is made up off a plurality of frame sections, each of which is connected to a plurality of the flexible arms 23. In the illustrated embodiment, the frame 22 is constructed of three arcuate frame sections 26a, 26b and 26c forming an annular outer frame 22; however, more or less frame sections can be provided, and the outer frame 22 can be of any suitable shape. The outer frame 22 can be easily expanded by pulling the three frame sections 26a, 26b and 26c in three different, but evenly spaced apart, radial directions, thereby stretching the flexible arms 23 and the openings 24a to 241 to a size large enough to receive the substrates without having to force them into position, i.e. without sliding or frictional contact. Releasing the outer frame sections 26a, 26b and 26c contracts the opening 24a to 241 to a size that enables the walls thereof to squeeze the substrates and hold them in position.

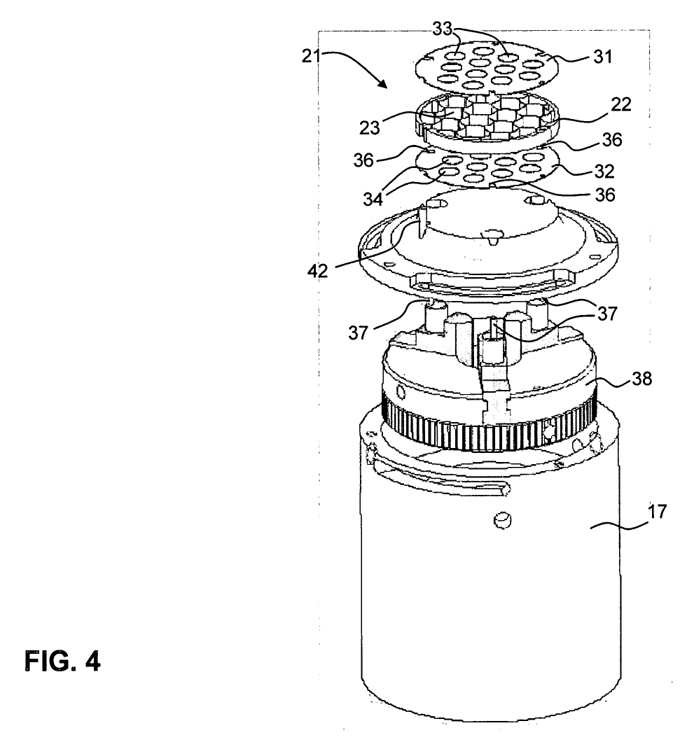

With reference to FIG. 4, the outer frame 22 has holes 28 extending therethrough for mounting at least one of a protective front cover 31 and a protective back cover 32 onto the substrate holder 21. Holes 33 and 34 in the front and back covers 31 and 32, respectively, are aligned with the openings 24a to 241 to enable the substrates placed therein to be coated. Ideally, neither the front or the back covers 31 and 32 will contact the delicate faces of the mirrors. Notches 36 in each of the protective covers 31 and 32 are provided to receive locking pins 37 extending from a chuck 38 of the rotating spindle 17 for mounting the substrate holder 21 directly to the rotating spindle 17. A protective face plate 39 covers the chuck 38 and secures the chuck 38 into the body of the rotating spindle 17. A key groove 41 is provided in the side of the frame 22 to ensure the substrate holder 21 is mounted correctly, i.e. in alignment with a key pin 42 on the face plate 39.

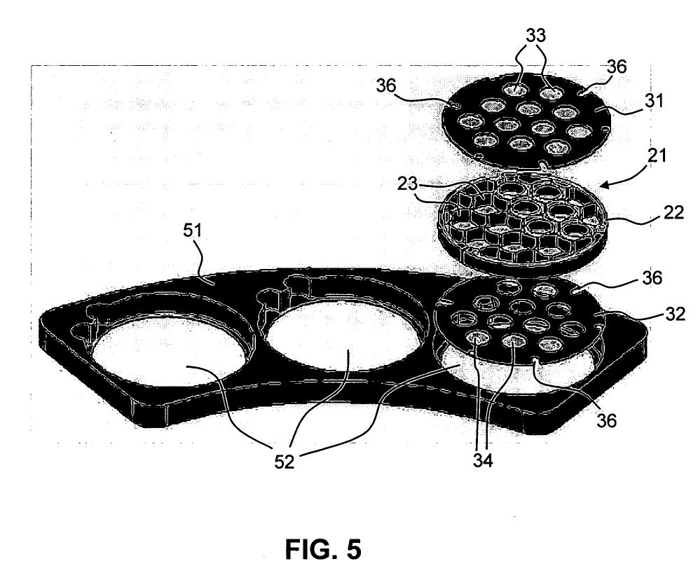

Alternatively, as illustrated in FIG. 5, a plurality of substrate holders 21 can be mounted in a mounting frame 51, which is subsequently mounted onto the rotating spindle 17. In the illustrated embodiment, the mounting frame 51 has curved inner and outer walls, and includes three recesses 52 aligned in an arcuate pattern.

We claim:

1. A device for holding a plurality of substrates comprising:
an outer frame defining an inner area; and
a plurality of interconnecting flexible arms extending from the outer frame into the inner area defining a plurality of openings with flexible walls, each opening sized to receive a substrate by deformation of the flexible walls.

2. The device according to claim 1, wherein the arms comprise sheet material.

3. The device according to claim 2, wherein the arms comprise sheet metal.

4. The device according to claim 1, wherein the flexible walls include arcuate sections bowing into each opening for squeezing the substrate therebetween.

5. The device according to claim 1, wherein each opening has six sides with alternating flexible walls flexing into the opening providing three points of contact for each substrate.

6. The device according to claim 1, wherein a plurality of the flexible walls are arcuate shaped flexing into the openings.

7. The device according to claim 6, wherein adjacent, arcuate-shaped, flexible walls flex in opposite directions, whereby one of the flexible wall flexes into one opening while an adjacent flexible wall flexes into an adjacent opening.

8. The device according to claim 7, wherein each opening has at least six sides with alternating flexible walls flexing into the opening providing at least three points of contact for each substrate.

9. The device according to claim 8, wherein the frame is expandable enabling each of the openings to expand large enough to enable the substrates to passes therethrough, whereby the substrates are captured in and released from the openings without sliding along the walls.

10. The device according to claim 9, wherein the frame comprises a plurality of separate frame sections for stretching the flexible walls in different directions.

11. The device according to claim 10, wherein the frame is annular, and comprises at least three arcuate frame sections.

12. The device according to claim 1, wherein the frame is expandable enabling each of the openings to expand large enough to enable the substrates to passes therethrough, whereby the substrates are captured in and released from the openings without sliding along the walls.

13. The device according to claim 12, wherein the frame comprises a plurality of separate frame sections for stretching the flexible walls in different directions.

14. The device according to claim 13, wherein the frame is annular, and comprises at least three arcuate frame sections.

15. The device according to claim 1, further comprising a front cover for protecting the outer frame including holes aligned with the openings.

16. The device according to claim 1, further comprising a front cover and a back cover for protecting the frame, each of the front and back cover having holes aligned with the openings.

17. The device according to claim 16, wherein the front and back covers are spaced apart from the substrates.
